(19) United States
(12) Patent Application Publication
(10) Pub. No.: US 2012/0275929 A1
(43) Pub. Date: Nov. 1, 2012

(54) FERROFLUID CONTROL AND SAMPLE COLLECTION FOR MICROFLUIDIC APPLICATION

(75) Inventor: Kenneth Salsman, Pleasanton, CA (US)

(73) Assignee: APTINA IMAGING CORPORATION, Grand Cayman (KY)

(21) Appl. No.: 13/172,105

(22) Filed: Jun. 29, 2011

Related U.S. Application Data
(60) Provisional application No. 61/479,581, filed on Apr. 27, 2011.

(51) Int. Cl. F04B 43/04; F15C 1/00

(52) U.S. Cl. 417/53; 417/322; 137/803

(57) ABSTRACT

A fluid conveyance system includes a flow passage and a cavity adjacent a side of the flow passage. A wall of the passage includes a flexible section that separates the cavity from the flow passage. The cavity contains a ferrofluidic material. The system further includes at least one magnetic field source positioned adjacent the flow channel. The magnetic field source is operable to move the ferrofluidic material in the cavity to exert a pressure on the flexible section and displace the flexible section into the flow passage to alter the flow of material through the passage. A method of collecting components from a sample volume includes the steps of distributing magnetic particles into the sample volume, capturing the components from the sample volume, and applying a magnetic field to the sample volume to control directional flow of the sample volume.

### CROSS REFERENCE TO RELATED APPLICATIONS

This application claims priority under 35 U.S.C. §119 to U.S. Provisional Application No. 61/479,581, filed Apr. 27, 2011, the content of which is incorporated by reference herein in its entirety.

### FIELD OF THE INVENTION

The present invention relates generally to fluid transport systems, and more specifically to fluid flow control systems that are driven by a ferrofluid and magnetic fields.

### BACKGROUND OF THE INVENTION

Microfluidic devices are applied in various fields, including biotechnology, chemical analysis and clinical chemistry. A microfluidic system features a network of conduits, channels or hollows formed on a base plate of plastic, glass or silicon substrate. The sizes of the channels are very small, and the transport of microfluids can be affected by the surface tension of the fluid and the wettability of the wall surfaces.

Current microfluidic systems utilize pneumatic, mechanical, and electromechanical or MEMS-based techniques to operate valves and perform mixing, directional flow, fluid transport and pumping functions. These techniques require relatively large pieces of equipment with various hose connections to provide the control and drive functions. Large pieces of equipment and hose assemblies are undesirable because they can consume large amounts of energy and occupy a significant amount of workspace, among other reasons.

Conventional pneumatic, mechanical, and electromechanical systems for pumping fluids have additional drawbacks when used in certain medical applications. For example, cardiopulmonary bypass machines (or heart-lung machines) typically utilize a peristaltic or roller pump to circulate blood through the body during surgery or other event when the heart and lungs do not function. Red blood cells are very sensitive to mechanical pressure, however, and can be destroyed by excessive pressure on the tubing. Conventional peristaltic pumps used with heart machines compress and constrict tubing that carries the blood cells, creating a risk of damage to the blood cells.

Some pneumatic, mechanical, and electromechanical transport systems allow pump or valve components to contact the fluid being pumped. Some fluid products chemically react with materials used in pumps and valves, making conventional pumps and valves inadequate.

Conventional heat transfer systems, like heat pipes that circulate water, ethanol, acetone, sodium, or mercury, suffer drawbacks because they require expensive materials and have limited application.

In view of the foregoing drawbacks, there is a need to improve existing systems and methods for mixing and transporting fluids, including both gases and liquids. There is also a need to improve existing microfluid transport systems.

### BRIEF DESCRIPTION OF THE DRAWINGS

The foregoing summary and detailed description that follows will be more clearly understood when read in conjunction with the drawing figures, wherein:

FIG. 1 is a truncated cross-sectional view of a microfluidic system in accordance with one embodiment of the invention, shown in a first mode of operation;

FIG. 2 is a truncated cross-sectional view of the microfluidic system of FIG. 1, shown in a second mode of operation;

FIG. 3 is a truncated cross-sectional view of a microfluidic system in accordance with another embodiment of the invention, shown in a first mode of operation;

FIG. 4 is a truncated cross-sectional view of the microfluidic system of FIG. 3, shown in a second mode of operation;

FIG. 5 is a truncated cross-sectional view of the microfluidic system of FIG. 3, shown in a third mode of operation;

FIG. 6 is a cross-sectional view of a fluid transport system in accordance with another embodiment of the invention;

FIG. 7 is a cross-sectional view of a fluid transport system in accordance with another embodiment of the invention;

FIG. 8 is a truncated cross-sectional view of a flow control system in accordance with another embodiment of the invention, shown in a first mode of operation; and

FIG. 9 is a truncated cross-sectional view of a flow control system in accordance with another embodiment of the invention, shown in a second mode of operation.

### DETAILED DESCRIPTION OF THE INVENTION

Although the invention is illustrated and described herein with reference to specific embodiments and examples, the invention is not intended to be limited to the details shown. Rather, various modifications may be made in the details within the scope and range of equivalents of the claims and without departing from the invention.

The drawbacks of conventional fluid transport systems, including conventional microfluidic systems, are resolved in many respects by utilizing ferrofluids in accordance with apparatuses, systems and processes of the invention. Apparatuses, systems and processes in accordance with the invention utilize ferrofluids and magnetic fields to perform various functions for fluid flow control, and are applicable to both microfluidic systems and conventional fluid transport systems.

Ferrofluids are comprised of nanoparticles of a ferric compound such as Fe₂0₃ that are suspended in a liquid in such a way that they stay in relatively homogeneous suspension. The ferric particles are coated with a surfactant, such as a sodium hydroxide, to reduce the surface tension between the particles and the liquid. The base of the fluid may be a moderate to low viscosity oil, such as mineral oil. When formulated correctly, the ferrofluid rapidly responds to the presence of a magnetic field by altering its shape to correspond to the magnetic field lines. This results in a fluid that can quickly and repeatedly change its shape, and even flow against gravity as it moves along the field lines.

### Fluid Membrane Valves and Pumps

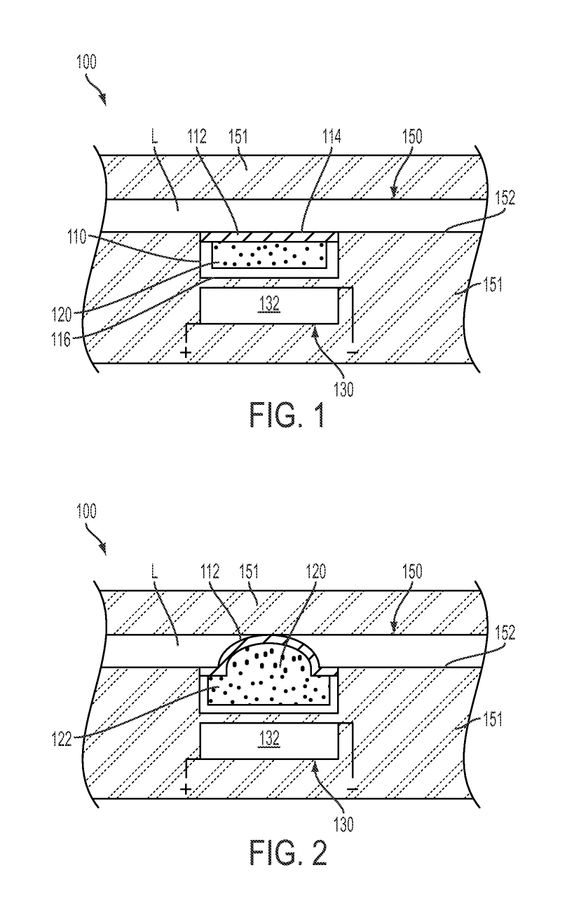

In one intended application, the magnetic properties of ferrofluids are utilized to generate pressure on microfluidic channels and structures to control flow and provide pumping pressure to gases or fluids in adjoining microchannels. FIGS. 1 and 2 schematically illustrate a ferrofluidic valve 100 in accordance with one embodiment of the invention. Valve 100 is positioned adjacent a microfluid conduit 150 formed in a substrate 151. Conduit 150 includes a micro flow channel 152 that carries a liquid L. Valve 100 includes a reservoir 110 containing a ferrofluid 120. Flow channel 152 is separated from the reservoir 110 by a flexible membrane 112 on a first side 114 of the reservoir. Valve 100 also includes a magnetic field source 130. Embodiments of the invention may feature various magnetic field sources and arrangements, including arrangements that utilize electromagnets or permanent magnets that are movable with mechanical control. Magnetic field source 130 includes an electromagnet 132, positioned on a second side 116 of reservoir 110, opposite first side 114.

Valve 100 is operable between an open mode, shown in FIG. 1, and a closed mode, shown in FIG. 2. Electromagnet 132 is configured to apply a magnetic field through reservoir 110 and displace ferrofluid 120 against flexible membrane 112. This is achieved by selecting a proper pole orientation and magnetic field strength that cause the ferrofluid 120 to push against the membrane 112 and distort the membrane so that it expands into the microfluidic channel. In this manner, it is possible to use the ferrofluid 120 to apply sufficient pressure to the membrane 112 to reduce or completely cut off the flow of liquid L in micro flow channel 152.

The thickness and elasticity of membrane 112 allow the membrane to flex in response to fluid pressure exerted by the ferric particles 122 in the magnetic field. At full power, the electromagnet 132 displaces the ferrofluid and creates sufficient pressure behind membrane 112 to expand the membrane into flow channel 152 until a section of the membrane contacts a wall section across from the membrane, as shown in FIG. 2. In this closed condition, membrane occupies and obstructs the cross sectional area of flow channel 152, preventing further flow of liquid L. Flow of liquid L is restored by cutting power to the electromagnet 152. When power to the electromagnet 152 is cut, the elasticity of membrane 112, and the stored energy resulting from the membrane's expansion, return the membrane to the unexpanded or open state shown in FIG. 1, allowing flow to resume.

Ferrofluid driven systems in accordance with the invention can also be used in pumping applications. In a preferred embodiment, multiple electromagnets are driven by an electrical signal generator such that the timing of the pressure being applied by the ferrofluid to the microfluidic channel occurs in a staggered timing sequence from one end of the ferrofluidic cavity to the other. In this manner, the compression of the microfluidic channel by the cascading row of electromagnets generates a preferred direction of pressure applied to the fluid in the microfluidic channel and generates a peristaltic pumping function. This architecture can also be used to perform a negative pressure pumping function by driving the entire length of the ferrofluidic channel to close the microfluidic channel over a length and then releasing the magnetic hold in sequence over the channel length. This will generate an increasing volume in the microfluidic channel as it expands to its normal dimensions, producing a pulling or negative pressure force on the fluid in the microfluidic channel. By incorporating both positive and negative pressure functions, a linear electromagnetic pump can generate significant pumping force within the microfluidic channel.

When using magnetic material such as materials used in magnetic core memories, it is possible to maintain a magnetic field between times where current is applied to an electromagnet. Electromagnetic field formation can be generated by placing a coil of conductive material around a volume of ferrofluid. Alternatively, a core made of ferric or similar material can be provided in specific locations in a flow system to concentrate the electromagnetic field and produce localized zones with significantly high field strength.

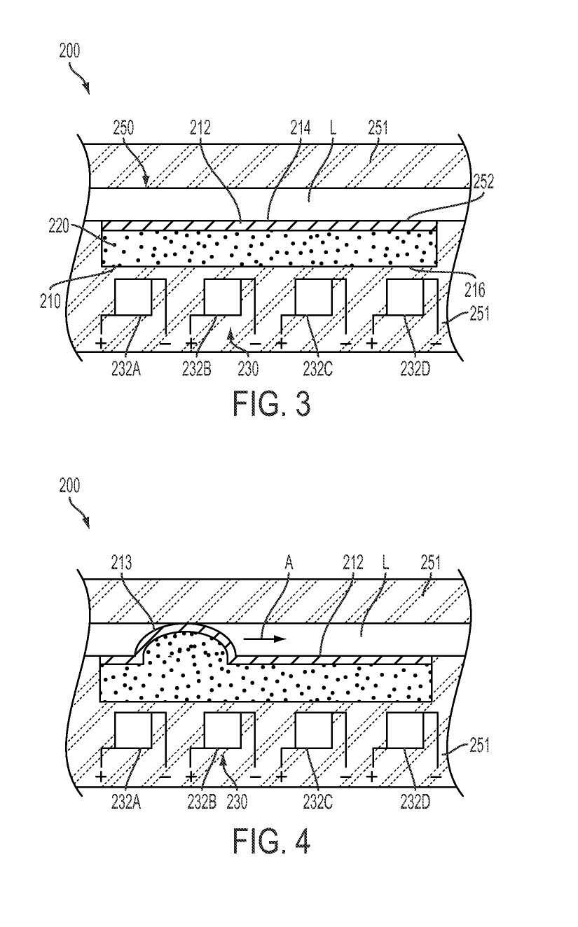

FIGS. 3-5 schematically illustrate one example of a ferrofluid driven pump 200 in accordance with the invention. Pump 200 is positioned adjacent a microfluid conduit 250 formed in a substrate 251 surrounding a micro flow channel 252. Flow channel 252 carries a liquid L. Pump 200 includes a reservoir 210 containing a ferrofluid 220. Flow channel 252 is separated from the reservoir 210 by a flexible membrane 212 on a first side 214 of the reservoir. Pump 200 also includes a magnetic field source 230. Magnetic field source 230 includes a series of electromagnets 232A-D arranged in a row along reservoir 210. Electromagnets 232A-D are positioned on a second side 216 of reservoir 210, opposite first side 214.

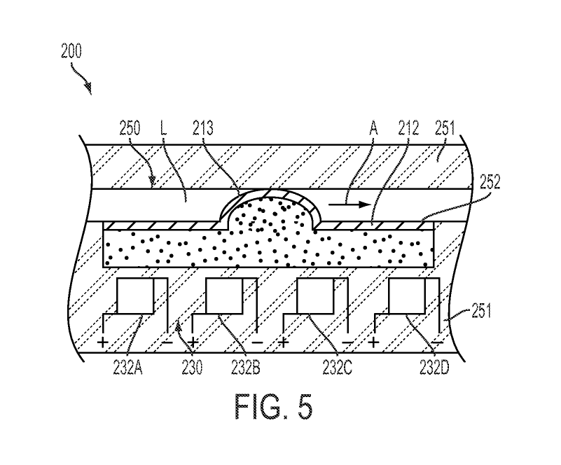

Pump 200 is operable to move fluid L along flow channel 252. Electromagnets 232A-D are activated individually and in a synchronized pattern to displace fluid L. FIG. 3 shows pump 200 in an off setting, with none of the electromagnets 232A-D activated. In FIG. 4, pump 200 is shown as it would appear after electromagnet 232A is activated, followed shortly after by electromagnet 232B. In this state, ferrofluid 220 displaces membrane 212 to create an occlusion 213 in flow channel 252. Membrane 212 is displaced from left to right in the figure, in response to the sequential activation of electromagnet 232A followed by electromagnet 232B. This sequential activation displaces liquid L in the direction represented by arrow A. FIG. 5 shows pump 200 with electromagnets 232A and 232B deactivated, and electromagnet 232C activated. Electromagnet 232C is activated shortly after activation of electromagnet 232B, resulting in a wave or ripple effect in flexible membrane 212. This ripple effect causes occlusion 213 to move along the flow channel in a continuous wave and displace liquid L in the direction represented by arrow A.

Occlusion 213 is schematically shown as completely obstructing flow channel 252. It will be understood that occlusion 213 need not fill or occupy the entire flow channel 252 to displace liquid L in the channel. The magnetic field and pressure behind membrane 212 may be adjusted so that the membrane only extends partially but not completely across flow channel 252. This option may be desirable where liquid L contains red blood cells or other components that are sensitive to mechanical pressure. Where red blood cells are transported in liquid L, a reduced pressure behind membrane 212 will ensure that blood cells are not crushed between the membrane and the wall of the flow channel.

Pump 200 is schematically shown with electromagnets in a linear arrangement. Pumps in accordance with the invention can also feature electromagnets arranged around a rotor arrangement, with a flow conduit arranged around the rotor, similar to a mechanical peristaltic pump.

### Sample Collection

Ferric nanoparticles with appropriate surfactants and sample bonding agents can be distributed within a sample volume to collect specific components of a sample for study, analysis, concentration or collection. Recovery of the particles with the bonded sample agents can be achieved using a magnetic field, and the sample can be manipulated within the sample analysis/storage architecture of a system via the ferrofluidic characteristic imparted to the sample.

In one embodiment of the invention, ferrite particles are treated to have a pseudo porous surface. Alternatively, the ferrite particles are coated with a protein that can then be coated with a trapping agent suitable for attaching to the component to be collected. These particles are much smaller than commercially available coated ferrite particles, allowing the particles to stay in suspension in gas as well as liquids.

After the ferrite particles have trapped the components to be collected, the ferrite particles are maintained in the sample volume to allow the flow direction of sample material to be controlled. That is, the sample material takes on the characteristics of a ferrofluid that can be precisely guided as it passes into the sample processing and analysis sections of a microfluid analysis or imaging system.

Electrostatic traps or electromagnetic bars can be employed to collect all the particles. By flowing fluid down the bars or adjusting the flow direction and applying alternate direction magnetic fields, the trapped sample component with the ferrite particles is driven to a collection/analysis point. The mass of each particle increases after the particle attaches to a trapped element. The trapped elements will have different masses from one particle to another. Flow speed and directional shifting are then used to separate the particles in gas (air) or liquids based on differences in mass and size so that components of different masses can be selectively collected and concentrated at different points.

Particles may also be separated by mass and collected for analysis using a ferromagnetic mass separator. The particles are dispersed in a microfluid and passed through a varying strength magnetic field or a curved pathway. The speed of each particle is dependent on its mass. Particles of different mass travel in different adjacent pathways and are separated such that they can be collected at different locations. The collected particles can be analyzed separately, or separated for additional processing. By using magnetic fields to impact the flow so as to separate the particles by mass, a continuous sample flow can be utilized and continuous separation can be provided. This has particular application for large samples, long term analysis/monitoring, and continuous processing applications.

The following section discusses different applications of ferrofluid control systems in accordance with the invention.

### EXAMPLES

### Example 1

### Fluid Driven Membrane Pump and Valve

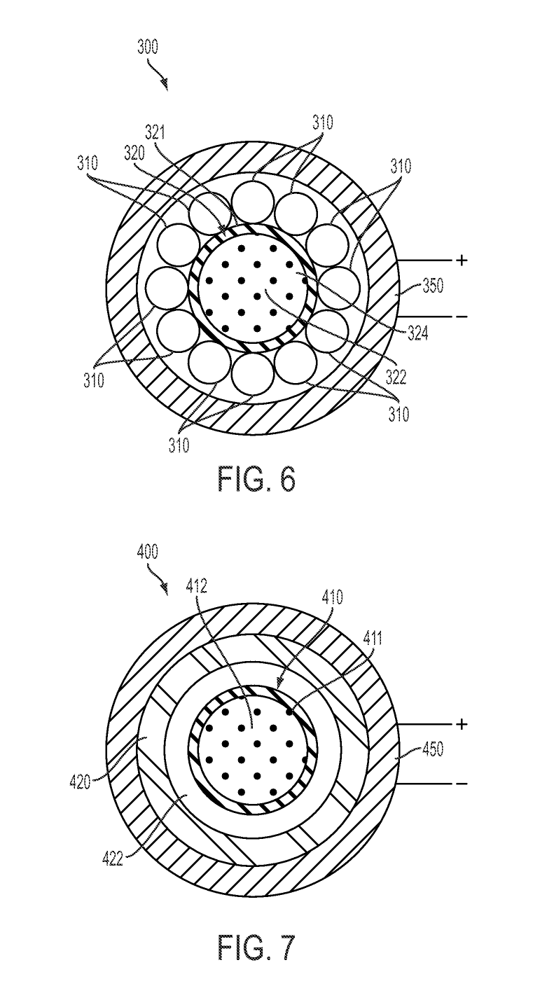

Referring to FIG. 6, a fluid driven pump 300 is shown in accordance with another embodiment of the invention. Pump 300 includes a cluster of flexible conduits 310 placed around a central flexible tube 320 containing a ferrofluid 322. An electromagnet 350 is placed externally to the flow conduits 310 and flexible tube 320. Electromagnet 350 is ring shaped and surrounds a section of the length of the conduits 310. A magnetic field is applied through the conduits 310 to interact with the ferrofluid 322. The magnetic field properties are selected through known techniques to pull ferric particles 324 in the ferrofluid in a radial outward direction. This creates a circular pressurized “wave” of ferrofluid that exerts radial outward pressure on the wall 321 of flexible tube 320. The pressure is sufficient to constrict the diameters of each of the flexible conduits 310 and displace fluid in the conduits.

Fluid is transported through the conduits in a chosen direction (for example, in a direction normal to the cross section shown in the Figure) by moving the magnetic field and ferrofluid wave in the chosen direction. The magnetic field is moved along the length of the conduit cluster and tube in the chosen direction to drive the ferrofluid wave and displace a volume of fluid in the flexible conduits in the chosen direction. The ferrofluid wave is driven by a series of electromagnets placed along the length of the conduit cluster, which are activated in a synchronized manner as discussed above to move the wave in the chosen direction. Repeated application of the magnetic field creates a fluid driven positive displacement pump. As opposed to mechanical displacement pumps that use rollers or shoes to compress the flow channel, fluid driven pumps in accordance with the invention can displace fluid under a precisely controlled pressure that does not damage pressure-sensitive components in the fluid.

Fluid driven membrane pumps in accordance with the invention are scaleable to any size and can be designed to accommodate various pumping capacities. Although a single cluster is shown in FIG. 6, the present invention also includes pumps that utilize multiple clusters grouped together in a contiguous assembly. In a preferred embodiment, clusters are bundled together to generate greater flow. Multiple clusters can be mounted together to create pumps of any capacity. Pumps in accordance with the invention can be driven in a synchronized manner so that all the pumping elements operate together, creating a peristaltic or pulsed flow. Alternatively, pumps in accordance with the invention can be driven out of sync, for example in phase steps, so that the flow is less forceful but continuous with little or no detectable pulsation. These pumps can be utilized in many applications ranging from medical applications (e.g. heart pumps) to marine uses (e.g. trolling motors, and bow/stern thrusters).

### Example 2

### Fluid Driven Membrane Pump and Valve

FIG. 7 shows a pump and valve system 400 similar to Example 1, except that the system uses a flexible tube 410 surrounded by a single pipe 420. Flexible tube 410 contains a ferrofluid 412, and pipe 420 is filled with a gas or liquid 422. A source of magnetic field in the form of an electromagnet 450 is positioned around the exterior of pipe 420. Electromagnet 450 is ring shaped and surrounds a section of the length of pipe 420. A magnetic field is applied through pipe 420 to interact with ferrofluid 412. The magnetic field properties are selected through known techniques to pull ferric particles in the ferrofluid in a radial outward direction. This creates a circular wave of ferrofluid that exerts a radially outward pressure on the wall of flexible tube 410. The outward pressure on tube 410 expands the tube wall 411, constricting and reducing the surrounding area in pipe 420. The ferrofluid wave is driven in a given axial direction along the axis of the pipe 420 by a series of electromagnets placed along the length of pipe 420.

### Example 3

### Pressure Surge Control

In another embodiment of the invention, a fluidic driven membrane is used for pressure surge control. The pressure surge control system has essentially the same arrangement and function as that shown in FIG. 1, except the flexible membrane expands into the flow channel in response to pressure surges that are detected in the system. A control system regulates the degree to which the membrane expands into the flow channel, the expansion being regulated as a function of pressure conditions or other variables. The system reduces or negates pressure surges by actively and dynamically altering the flow dimensions and shape of the flow in the pipe.

### Example 4

### Ferrofluid Valve

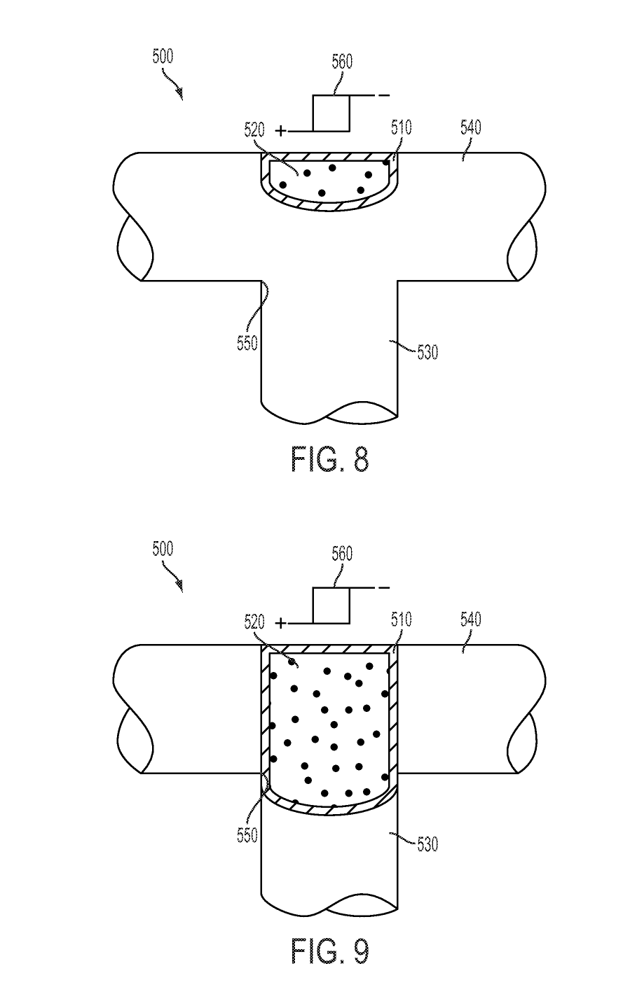

FIGS. 8 and 9 show a ferrofluid valve 500 having a “balloon” like membrane 510 filled with ferrofluid 520. Membrane 510 is connected to a side wall of a flow channel. Valve 500 is mounted inside a “T” intersection between two pipes 530 and 540, with membrane 510 anchored above an opening 550 where pipe 530 enters pipe 540. An electromagnet 560 is mounted on the pipe intersection adjacent membrane 510.

As magnetic force is applied by electromagnet 560, the ferrofluid 520 is driven toward one region of the balloon. With enough magnetic force, ferrofluid 520 exerts sufficient pressure inside membrane 510 to expand the membrane toward pipe 530 and obstruct opening 550, thereby blocking flow. Valve 500 provides extremely precise adjustment of flow and can change flow nearly instantaneously, much faster than mechanical valves. Without any mechanical surfaces, the ferrofluid valve 500 does not have any mechanical parts to wear out or leak. Membranes enclosed with ferrofluid in accordance with the invention can be used to regulate the flow of gases or liquids in a pipe.

By utilizing membranes filled with ferrofluids and magnetic force patterning, simple non-mechanical systems can be created that have a wide range of applications. Ferrofluid driven systems in accordance with the invention eliminate the drawbacks of conventional fluid transport systems. For example, ferrofluid driven pumps and valves require no external openings to access the components of the pump or valve, and only require a magnetic field source positioned outside of the membrane. Ferrofluidic membrane devices in accordance with the invention can provide higher reliability, lower cost, faster operation, and cover a wider range of functionality than conventional fluid transport systems. In addition, ferrofluidic membrane devices in accordance with the invention can be leveraged with diaphragm based regulators and similar devices that can be used to generate a wide range of functional capabilities.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A microfluidic conveyance system comprising:
a microfluidic flow channel comprising a wall forming a flow passage, the flow passage having a first side and a second side opposite the first side;
a cavity adjacent the first side of the flow passage, the wall comprising a flexible section that separates the cavity from the flow passage;
a ferrofluidic material in the cavity; and
at least one magnetic field source positioned adjacent the microfluidic flow channel,
wherein the at least one magnetic field source is operable to apply a magnetic field to the ferrofluidic material in the cavity to displace the ferrofluidic material in the cavity against the flexible section of the wall and exert a pressure on the flexible section to cause the flexible section to project into the microfluidic flow channel and occupy at least a portion of the microfluidic flow channel.

2. The microfluidic conveyance system of claim 1, wherein the at least one magnetic field source is positioned adjacent the second side of the flow passage.

3. The microfluidic conveyance system of claim 1, wherein the cavity is arranged between the at least one magnetic field source and the flow passage.

4. The microfluidic conveyance system of claim 1, wherein the cavity extends along a segment of the microfluidic flow channel, the length of the segment being less than the length of the microfluidic flow channel.

5. The microfluidic conveyance system of claim 1, wherein the cavity extends along the entire length of the microfluidic flow channel.

6. The microfluidic conveyance system of claim 1, wherein the at least one magnetic field source comprises a plurality of magnetic field sources arranged in a row along the flow channel, the row having a first end and a second end.

7. The microfluidic conveyance system of claim 6, wherein the plurality of magnetic field sources are incrementally arranged along the row and are spaced uniformly apart from one another at equal distances.

8. The microfluidic conveyance system of claim 6 comprising an electric signal generator operable to activate the plurality of magnetic field sources one at a time and in a staggered timing sequence along the row.

9. The microfluidic conveyance system of claim 6 comprising an electric signal generator operable to activate the plurality of magnetic field sources one at a time and in a synchronized manner to displace a fluid in the fluid channel.

10. The microfluidic conveyance system of claim 1, wherein the ferrofluid comprises Fe₂O₃.

11. The microfluidic conveyance system of claim 1, wherein the ferrofluid comprises a base consisting of mineral oil.

12. The microfluidic conveyance system of claim 1, wherein the cavity, ferrofluidic material and at least one magnetic field source from a valve at a single location along the flow channel.

13. A microfluidic conveyance system comprising:
a microfluidic flow channel comprising a wall forming a flow passage, the flow passage having a first side and a second side opposite the first side;
a cavity adjacent the first side of the flow passage, the wall comprising a flexible section that separates the cavity from the flow passage;
a ferrofluidic material in the cavity;
at least one magnetic field source positioned adjacent the microfluidic flow channel; and
a ferrofluid in the microfluidic flow channel, the ferrofluid comprising a plurality of ferric nanoparticles.

14. The microfluidic conveyance system of claim 13, wherein each of the plurality of ferric nanoparticles comprises a surfactant and a bonding agent.

15. The microfluidic conveyance system of claim 13, wherein the magnetic field source generates a varying strength magnetic field on the ferric nanoparticles such that the ferric nanoparticles are separated according to mass.

16. The microfluidic conveyance system of claim 14, wherein the bonding agent comprises an antigen, an antibody or a protein coating.

17. The microfluidic conveyance system of claim 13, wherein the at least one magnetic field source is positioned adjacent the second side of the flow passage.

18. The microfluidic conveyance system of claim 13, wherein the cavity is arranged between the at least one magnetic field source and the flow passage.

19. The microfluidic conveyance system of claim 13, wherein the cavity extends along a segment of the microfluidic flow channel, the length of the segment being less than the length of the microfluidic flow channel.

20. A microfluidic method of collecting components from a sample volume for analysis, the method comprising the steps of:
distributing a plurality of magnetic nanoparticles into the sample volume, the magnetic nanoparticles each coated with a surfactant and a bonding agent;
capturing the components from the sample volume using the coated magnetic nanoparticles;
applying a first magnetic field to the sample volume to direct the nanoparticles and captured components into a microfluid flow channel, the microfluid flow channel comprising a wall forming a flow passage, the wall comprising a flexible section;
applying a second magnetic field to a cavity containing a ferrofluid, the cavity located outside the flow channel and adjacent to the flexible section;
creating a pressure gradient in the ferrofluid using the second magnetic field to exert pressure against the flexible section and displace the flexible section into the microfluid flow channel; and
displacing the flexible section at incrementally spaced locations along the microfluid flow channel in a desired flow direction to convey the nanoparticles and captured components through the microfluid flow channel in the desired flow direction.
